(19) United States
(12) Patent Application Publication
(10) Pub. No.: US 2011/0255716 A1
(43) Pub. Date: Oct. 20, 2011

(54) DIAPHRAGM AND CONDENSER MICROPHONE USING SAME

(76) Inventors: Zhou GE, Shenzhen (CN); Rui Zhang, Shenzhen (CN)

(21) Appl. No.: 12/978,579

(22) Filed: Dec. 26, 2010

(30) Foreign Application Priority Data
Apr. 19, 2010 (CN) 201010153569.3

(51) Int. Cl. H04R 1/00; G10K 13/00

(52) U.S. Cl. 381/174; 181/158

(57) ABSTRACT

A diaphragm is disclosed. A diaphragm includes a vibrating member capable of vibrating relative to the backplate and suspended by the supporting member extending from the vibrating member. The supporting member extends from a periphery of the vibrating member along a direction away from the centre of the diaphragm. The supporting member defines a first surface, a second surface facing to the first surface, a side wall connecting the first surface and the second surface. And the side wall defines a first side wall and a second side wall facing to the first side wall. The supporting member defines a first groove, a second groove. Along a direction parallel to the vibrating member, the first groove extends from the second side wall to the first side wall, with a first placket in the first side wall, and the second groove extends from the first side wall to the second side wall, with a second placket in the second side wall.

### BACKGROUND OF THE INVENTION

1. Field of the Invention

The present invention generally relates to the art of microphones and, more particularly, to a diaphragm of a microphone manufactured by MEMS technology.

2. Description of Related Art

Silicon based condenser microphones, known as acoustic transducers, have been researched and developed for more than 20 years. Because of potential advantages in miniaturization, performance, reliability, environmental endurance, low cost, and mass production capability, silicon based microphones are widely recognized to be the next generation product to replace electret condenser microphones (ECM) that has been widely used in communication devices, multimedia players, and hearing aids.

A related silicon based condenser microphone comprises a backplate having a planar plate with a plurality of perforations therein, and a diaphragm parallel and opposed to the backplate for forming a capacitor. The diaphragm can be activated to move along a direction perpendicularly to the planar plate of the backplate.

The diaphragm is very important to the silicon based condenser microphone. In general, the diaphragm is supported by some fixing members distributing at the periphery of the diaphragm symmetrically. But it is difficult to release stress of the diaphragm of such structure, which will influence the sensitivity and coherence of the microphone. The present invention is provided to solve the problems mentioned above.

### BRIEF DESCRIPTION OF THE DRAWINGS

FIG. 1 is a cross-sectional view of a condenser microphone using a diaphragm in accordance with one embodiment of the present invention;

FIG. 2 is an isometric view of the diaphragm in FIG. 1; and

FIG. 3 is an enlarged view of the circled Part A in FIG. 2.

### DETAILED DESCRIPTION OF THE EXEMPLARY EMBODIMENT

Reference will now be made to describe the exemplary embodiment of the present invention in detail.

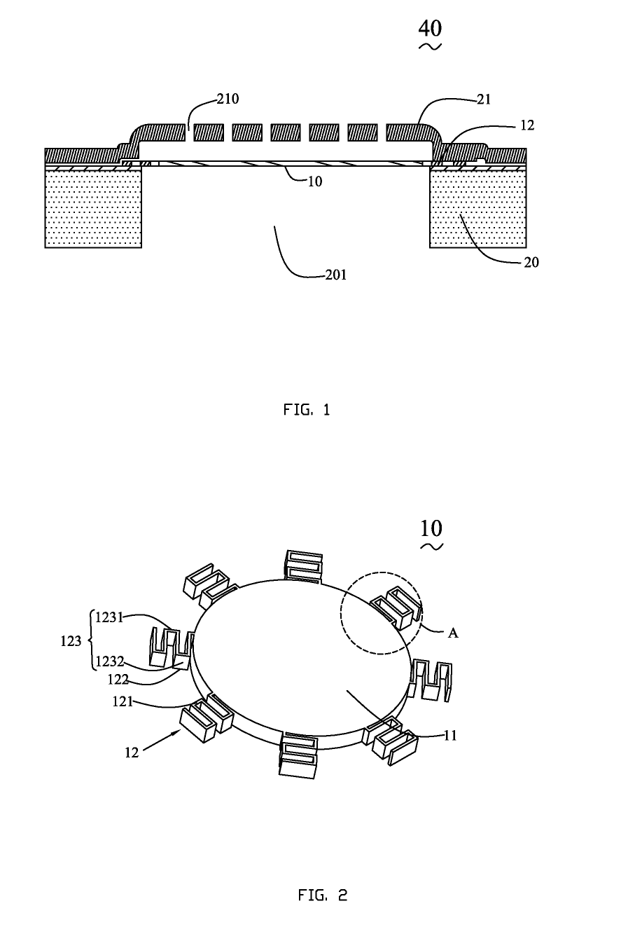

Electronic devices, especially portable devices, such as mobile phones generally use condenser microphones for receiving sound waves and then converting the sound waves to electrical signals. Referring to FIG. 1, a condenser microphone 40 comprises a substrate 20 having a through cavity 201, a backplate 21 connected to the substrate 20 and defining a plurality of sound holes 210 and a diaphragm 10 opposed to the backplate for forming a capacitor. The diaphragm 10 is secured to the substrate by a plurality of supporting members 12.

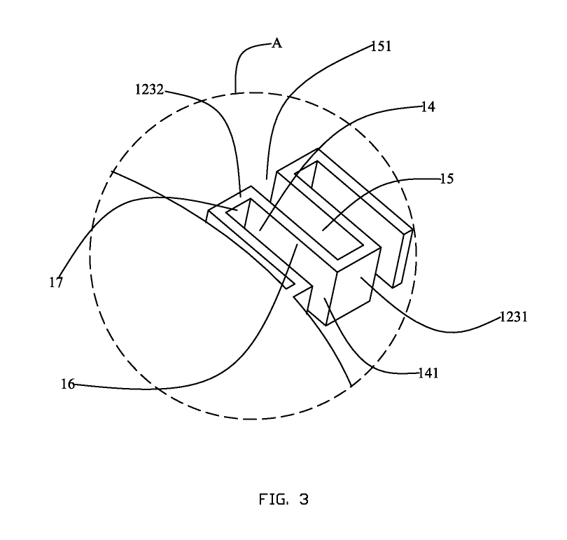

Referring to FIGS. 2-3, the diaphragm 10 comprises a vibrating member 11 capable of vibrating relative to the backplate 21 and suspended by the supporting member 12 extending from the vibrating member 11. The supporting member 12 extends from a periphery of the vibrating member 11 along a direction away from the centre of the diaphragm 10. The supporting member 12 defines a first surface 121 parallel to the vibrating member 11, a second surface 122 parallel and facing to the first surface 121, a side wall 123 connecting the first surface 121 and the second surface 122. The side wall 123 defines a first side wall 1231 connecting the first and second surfaces at one end and a second side wall 1232 connecting the first and second surfaces at another opposite end. The first side wall 1231 is parallel to the second side wall 1232. The supporting member 12 defines a first groove 14 and a second groove 15. Along a direction parallel to the vibrating member 11, the first groove 14 extends from the second side wall 1232 to the first side wall 1231, with a first placket 141 in the first side wall 1231, and the second groove 15 extends from the first side wall 1231 to the second side wall 1232, with a second placket 151 in the second side wall 1232.

Along a direction perpendicularly to the vibrating member 11, the first groove 14 has an opening in the first surface 121 and the second surface 122, respectively. The second groove 15 may also has an opening in the first surface 121 and the second surface 122, respectively.

Alternatively, the first groove 14 may have an opening in the first surface or in the second surface and a bottom between the first surface and the second surface, and the second groove 15 may has an opening in the first surface or in the second surface and a bottom between the first surface and the second surface. It is preferable that a depth of the first groove 14 or the second groove 15 is half a distance from the first surface 121 to the second surface 122.

In fact, the diaphragm 10 may be described in another manner, as follows. Referring to FIGS. 2-3, the diaphragm 10 includes a vibrating member 11, and a plurality of supporting members 12 extending from a periphery of the vibrating member 11. Each of the supporting members 12 includes a linking member extending perpendicularly from the periphery of the vibrating member 11, a plurality of transverse beams 17 perpendicularly to the linking member, and a plurality of longitudinal beams 16 parallel to the linking member. One of the transverse beams 17 is connected to an adjacent transverse beam by one longitudinal beam at one end thereof, and is connected to another adjacent transverse beam by another longitudinal beam at another end thereof. Grooves are defined between every two adjacent transverse beams. The transverse beams define a top surface and a lower surface. The groove may have a bottom located between the top surface and the lower surface. If having a bottom, a depth of the groove is half a distance from the top surface and the lower surface.

Because of the structure of the diaphragm mentioned above, it can free a stress by minishing a stress grads which other structure layers acting to the diaphragm and improve a sensitivity by minishing a rigidity of the diaphragm. It also improves a rigidity of a flexuosity in order to improve a reliability and a ratio of the finished product in such structure. Such structure of the diaphragm mentioned above also optimize a damp of the diaphragm to enhance accacoustic performance.

While the present invention has been described with reference to the specific embodiment, the description of the invention is illustrative and is not to be construed as limiting the invention. Various of modifications to the present invention can be made to the embodiment by those skilled in the art without departing from the true spirit and scope of the invention as defined by the appended claims.

What is claimed is:

1. A diaphragm comprising:
a vibrating member;
a supporting member extending from a periphery of the vibrating member along a direction away from the centre of the diaphragm;
the supporting member defining
a first surface parallel to the vibrating member;
a second surface parallel and facing to the first surface;
a side wall perpendicular to and connecting the first surface to the second surface and defining a first side wall and a second side wall facing to the first side wall; wherein
the supporting member defines a first groove extending from the second side wall to the first side wall with a first placket in the first side wall, and a second groove extending from the first side wall to the second side wall with a second placket in the second side wall.

2. The diaphragm as described in claim 1, wherein the first groove or the second groove runs through the first surface and the second surface.

3. The diaphragm as described in claim 1, wherein a depth of the first groove or the second groove is half a distance from the first surface to the second surface.

4. A diaphragm for a condenser microphone, comprising:
a vibrating member;
a plurality of supporting members extending from a periphery of the vibrating member, wherein
each of the supporting member includes a linking member extending perpendicularly from the periphery of the vibrating member, a plurality of transverse beams vertical to the linking member, and a plurality of longitudinal beams parallel to the linking member, and one of the transverse beam is connected to an adjacent transverse beam by a longitudinal beam at one end thereof, and is connected to another adjacent transverse beam by another longitudinal beam at another end thereof

5. A condenser microphone comprising:
a substrate having a through cavity;
a backplate connected to the substrate and defining a plurality of sound holes;
a diaphragm opposed to the backplate for forming a capacitor and comprising:
a vibrating member;
a plurality of supporting members extending from a periphery of the vibrating member, wherein
each of the supporting member includes a linking member extending perpendicularly from the periphery of the vibrating member, a plurality of transverse beams vertical to the linking member, and a plurality of longitudinal beams parallel to the linking member, and
one of the transverse beams is connected to an adjacent transverse beam by a longitudinal beam at one end thereof, and is connected to another adjacent transverse beam by another longitudinal beam at another end thereof
